(19) United States
(12) Patent Application Publication
(10) Pub. No.: US 2024/0137515 A1
(43) Pub. Date: Apr. 25, 2024

(54) FLIPPING MODE FOR CHROMA AND INTRA TEMPLATE MATCHING

(71) Applicant: Tencent America LLC, Palo Alto, CA (US)

(72) Inventors: Xin ZHAO, San Jose, CA (US); Guichun LI, San Jose, CA (US); Lien-Fei CHEN, Hsinchu (TW); Xiaozhong XU, State College, PA (US); Shan LIU, San Jose, CA (US)

(73) Assignee: Tencent America LLC, Palo Alto, CA (US)

(21) Appl. No.: 18/382,922

(22) Filed: Oct. 22, 2023

Related U.S. Application Data
(60) Provisional application No. 63/418,944, filed on Oct. 24, 2022.

(51) Int. Cl. H04N 19/132; H04N 19/103; H04N 19/176; H04N 19/184

(52) U.S. Cl. CPC H04N 19/132; H04N 19/103; H04N 19/176; H04N 19/184

(57) ABSTRACT

A video bitstream comprising coding information of a current block in a current picture is received. The coding information indicates that the current block is coded by a flip mode in which locations of samples of the current block are adjusted within the current block. A reference block is determined from a plurality of candidate reference blocks in a reconstructed region of the current picture for the current block based on template matching (TM) costs. The TM costs indicate differences between a template of the current block and respective templates of the plurality of candidate reference blocks. A reconstruction block of the current block is determined based on the determined reference block. The current block is reconstructed by adjusting locations of samples of the reconstruction block within the reconstruction block based on the flip mode.

### INCORPORATION BY REFERENCE

The present application claims the benefit of priority to U.S. Provisional Application No. 63/418,944, “Flipping Mode for Chroma and Intra Template Matching” filed on Oct. 24, 2022, which is incorporated by reference herein in its entirety.

### TECHNICAL FIELD

The present disclosure describes embodiments generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding. In some examples, an apparatus for video decoding includes processing circuitry.

According to an aspect of the disclosure, a method of video decoding is provided. In the method, a video bitstream comprising coding information of a current block in a current picture is received. The coding information indicates that the current block is coded by a flip mode in which locations of samples of the current block are adjusted within the current block. A reference block is determined from a plurality of candidate reference blocks in a reconstructed region of the current picture for the current block based on template matching (TM) costs. The TM costs indicate differences between a template of the current block and respective templates of the plurality of candidate reference blocks. A reconstruction block of the current block is determined based on the determined reference block. The current block is reconstructed by adjusting locations of samples of the reconstruction block within the reconstruction block based on the flip mode.

In an example, the flip mode includes one of (i) a vertical flip mode configured to adjust the locations of the samples of the current block such that an upper part and a lower part of the current block are reversed within the current block, and (ii) a horizontal flip mode configured to adjust the locations of the samples of the current block such that a left part and a right part of the current block are reversed within the current block.

In an example, first coding information is received from the received video bitstream. The first coding information indicates whether the flip mode is to be applied to the reconstruction block. In response to the first coding information indicating that the flip mode is to be applied to the reconstruction block, a type of the flip mode is determined based on second coding information in the received video bitstream. The current block is reconstructed by adjusting the locations of the samples of the reconstruction block based on the determined type of the flip mode.

In an example, the plurality of candidate reference blocks is determined within a search region of the reconstructed region of the current picture. The TM costs between the template of the current block and a template of each of the plurality of candidate reference blocks are determined. The reference block is determined from the plurality of candidate reference blocks that corresponds to a minimum TM cost among the TM costs between the template of the current block and the templates of the plurality of candidate reference blocks.

In an example, based on the flip mode being a horizontal flip, a vertical range of the search region is smaller than a horizontal range of the search region. In an example, based on the flip mode being a vertical flip, the vertical range of the search region is larger than a horizontal range of the search region.

In an example, the determined reference block is further flipped by adjusting locations of samples of the determined reference block within the determined reference block based on the flip mode. The reconstruction block is determined based on the flipped reference block.

According to another aspect of the disclosure, a method of video decoding is provided. In the method, a video bitstream comprising a current chroma block and a collocated luma block of the current chroma block in a current picture is determined. Whether a characteristic value of the collocated luma block is larger than a predefined threshold value is determined. The characteristic value is associated with one or more predefined coding modes that is applied to the collocated luma block. Based on the characteristic value being larger than the predefined threshold value, chroma coding mode information of the current chroma block is determined based on luma coding mode information of a predefined luma block. The current chroma block is reconstructed based on the determined chroma coding mode information.

In an example, the characteristic value indicates one of (i) a number of luma collocated block positions in the collocated luma block that is coded by the one or more predefined coding modes, (ii) a size of a luma area in the collocated luma block that is coded by the one or more predefined coding modes, and (iii) a ratio of a luma area in the collocated luma block that is coded by the one or more predefined coding modes.

In an example, the luma collocated block positions include a center position and four corner positions of the collocated luma block.

In an example, the one or more predefined coding modes include at least one of an intra block copy (IBC) flipping mode, an IBC mode indicating by a block vector (BV), an IBC rotation mode, and an IBC geometric partition mode.

In an example, the one or more predefined coding modes include at least one of an intra template matching prediction (IntraTMP) flipping mode and an IntraTMP mode indicated by a displacement vector.

In an example, the chroma coding mode information of the current chroma block is determined based on one of (i) luma coding mode information of a first luma block that is coded by the one of the one or more predefined coding modes along a predefined scanning order, (ii) luma coding mode information of a most frequently used mode among the luma collocated block positions that are coded by the one or more predefined coding modes, and (iii) first luma coding mode information of the one or more predefined coding modes that is used more than N times along a predefined scanning order, where N is a positive integer.

In an example, the chroma coding mode information of the current chroma block is determined based on luma coding mode information of a sample at a predefined collocated luma position. The sample at the predefined collocated luma position is coded by one of the one or more predefined coding modes, and the predefined collocated luma position includes one of a center position and a top-left position of the collocated luma block.

In an example, based on the one or more predefined coding modes including an IntraTMP mode, a plurality of candidate reference chroma blocks is determined within a search range in the current picture that is indicated by a block vector (BV) of the current chroma block. The BV of the current chroma block is determined based on one of a plurality of associated luma blocks. The plurality of associated luma blocks includes (i) a first IntraTMP coded block along a predefined scanning order, (ii) the collocated luma block, and (iii) an IntraTMP coded block corresponding to first IntraTMP mode information that is used more than N times along a predefined scanning order. A plurality of flip modes is determined for each of the plurality of candidate reference chroma blocks. TM cost between a template of each of the plurality of candidate reference chroma blocks and a template of the current chroma block are determined according to a respective flip mode of the plurality of flip modes. A flip mode is determined from the plurality of flip modes that corresponds to a smallest TM cost among the TM costs between the template of each of the plurality of candidate reference chroma blocks and the template of the current chroma block according to the plurality of flip modes. A flip mode of the current chroma block is determined as the determined flip mode from the plurality of flip modes.

In an example, the BV of the current chroma block is determined as a scaled BV of the one of the plurality of associated luma blocks based on a scaling factor, where the scaling factor is determined based on a subsampling ratio associated with the current chroma block.

In an example, the chroma coding mode information of the current chroma block is determined based on scaled luma coding mode information of the predefined luma block according to a scaling factor, where the scaling factor is determined based on a sampling format of the current chroma block.

According to another aspect of the disclosure, an apparatus is provided. The apparatus includes processing circuitry. The processing circuitry can be configured to perform any of the described methods for video decoding/encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary block diagram of a communication system (100).

FIG. 2 is a schematic illustration of an exemplary block diagram of a decoder.

FIG. 3 is a schematic illustration of an exemplary block diagram of an encoder.

FIGS. 4A, 4B, 4C, and 4D show exemplary reference samples for an intra block copy (IBC) process.

FIG. 5 is a schematic illustration of an exemplary block vector (BV) adjustment based on a horizontal flip.

FIG. 6 is a schematic illustration of an exemplary BV adjustment based on a vertical flip.

FIG. 7 is a schematic illustration of an intra template matching prediction (IntraTMP).

FIG. 8 shows a flow chart outlining a first decoding process according to some embodiments of the disclosure.

FIG. 9 shows a flow chart outlining a first encoding process according to some embodiments of the disclosure.

FIG. 10 shows a flow chart outlining a second decoding process according to some embodiments of the disclosure.

FIG. 11 shows a flow chart outlining a second encoding process according to some embodiments of the disclosure.

FIG. 12 is a schematic illustration of a computer system in accordance with an embodiment.

### DETAILED DESCRIPTION OF EMBODIMENTS

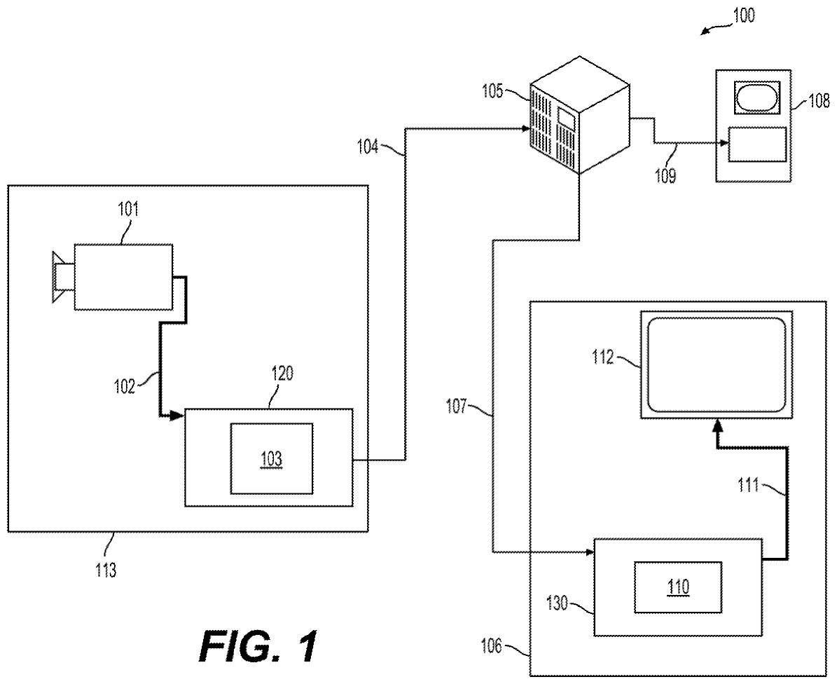

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

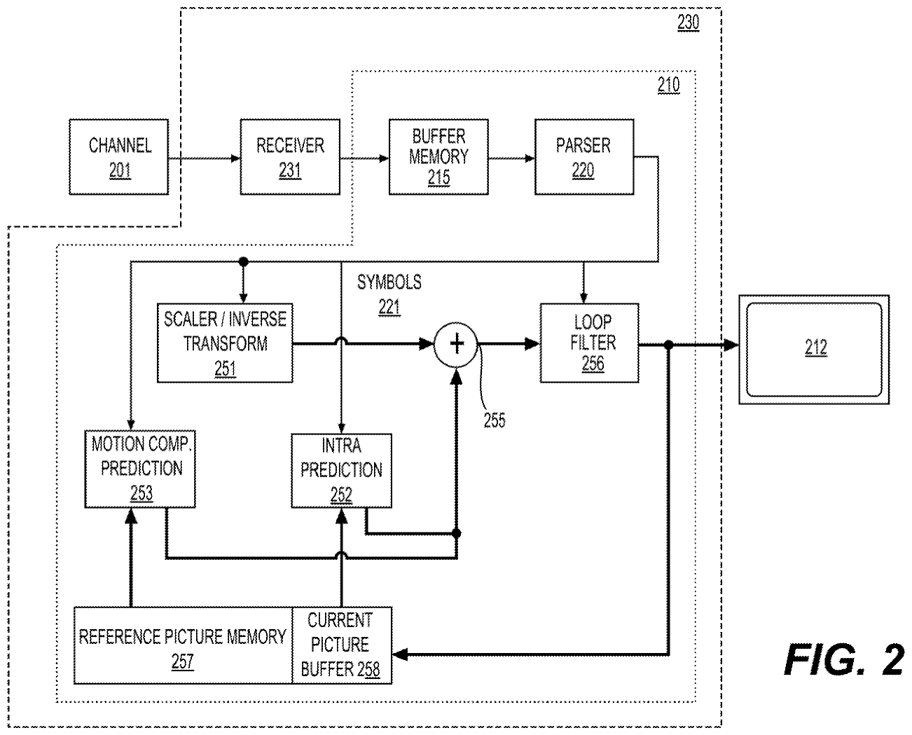

FIG. 2 shows an exemplary block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an embodiment, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

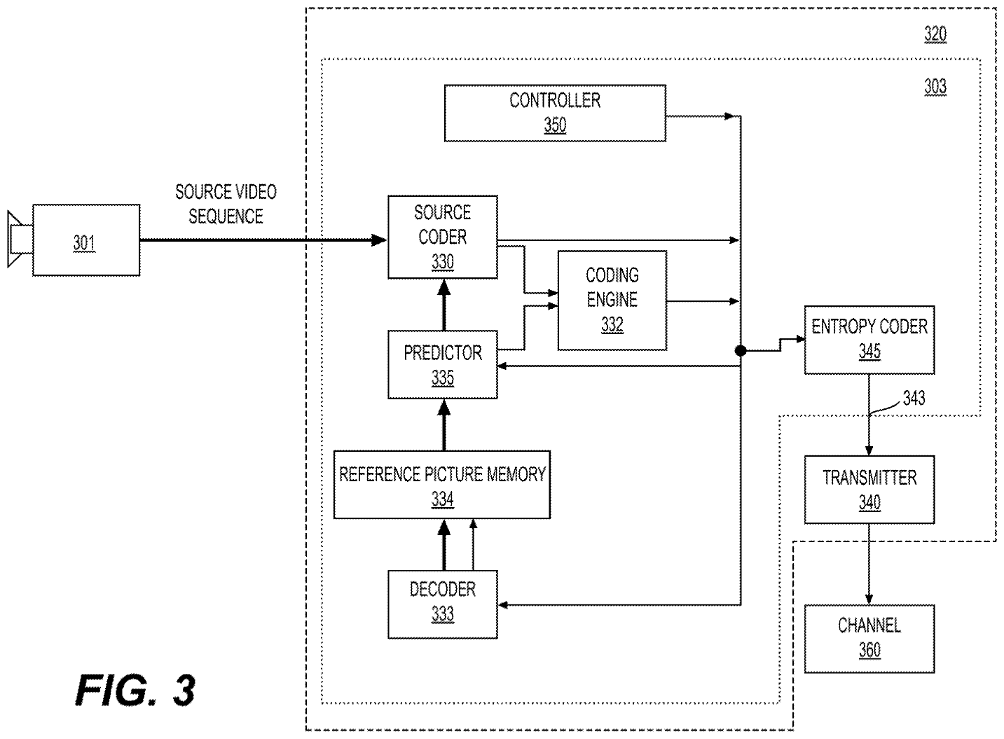

FIG. 3 shows an exemplary block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an embodiment, the video encoder (303) may code and compress the pictures of the source video sequence into a coded video sequence (343) in real time or under any other time constraints as required. Enforcing appropriate coding speed is one function of a controller (350). In some embodiments, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some embodiments, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an embodiment, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an embodiment, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some embodiments, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some embodiments of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an embodiment, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an embodiment, the video encoders (103) and (303) and the video decoders (110) and (210) can be implemented using one or more integrated circuits. In another embodiment, the video encoders (103) and (303), and the video decoders (110) and (210) can be implemented using one or more processors that execute software instructions.

This disclosure includes aspects related to inheriting luma intra block copy (IBC) mode information and/or luma IntraTMP mode information for a chroma color component and applying a flipping mode for IntraTMP coded blocks.

IBC, or current picture referencing (CPR), is a tool that can be used to improve coding efficiency of screen content materials, such as adopted in HEVC extensions on screen content coding (SCC). Since IBC mode can be implemented as a block-level coding mode, block matching (BM) can be performed at an encoder to find an optimal block vector (or motion vector) for each CU. Here, a block vector can be used to indicate a displacement from a current block to a reference block, where the reference block was already reconstructed inside a current picture. A luma block vector of an IBC-coded CU can be defined in an integer precision. A chroma block vector can be rounded to the integer precision as well. When combined with adaptive motion vector resolution (AMVR), the IBC mode can switch between 1-pel and 4-pel motion vector precisions. An IBC-coded CU can be treated as a third prediction mode other than intra or inter prediction modes. The IBC mode can be applicable to CUs with both a width and a height smaller than or equal to 64 luma samples.

At an encoder side, a hash-based motion estimation can be performed for IBC. The encoder can perform a rate distortion (RD) check for blocks with either a width or a height no larger than 16 luma samples. For a non-merge mode, a block vector search can be performed using a hash-based search first. If the hash-based search does not return a valid candidate, a block matching-based local search can be performed.

In the hash-based search, hash key matching (32-bit CRC) between a current block and a reference block can be extended to allowed block sizes. A hash key calculation for every position in a current picture can be based on 4×4 subblocks. For a current block with a larger size, a hash key can be determined to match a hash key of the reference block when all the hash keys of all 4×4 subblocks match the hash keys in the corresponding reference locations. If hash keys of multiple reference blocks are found to match the harsh key of the current block, a block vector cost of each matched reference block can be calculated and a matched reference block with a minimum cost can be selected.

In a block matching search, a search range can be set to cover both previous and current CTUs. At a CU level, IBC mode can be signalled with a flag and the IBC mode can be signaled as an IBC advanced motion vector prediction (AMVP) mode or an IBC skip/merge mode. Examples of the AMVP mode and IBC skip/merge mode are as follows:

(1) IBC skip/merge mode: a merge candidate index can be used to indicate which one of the block vectors in the list from neighboring candidate IBC coded blocks is used to predict the current block. The merge list can include spatial, history-based MVP (HMVP), and pairwise candidates.

(2) IBC AMVP mode: a block vector difference can be coded in a same way as a motion vector difference. The block vector prediction method can use two candidates as predictors, one from a left neighbor and one from an above neighbor (if IBC coded). When either the left neighbor or the above neighbor is not available, a default block vector can be used as a predictor. A flag can be signaled to indicate a block vector predictor index.

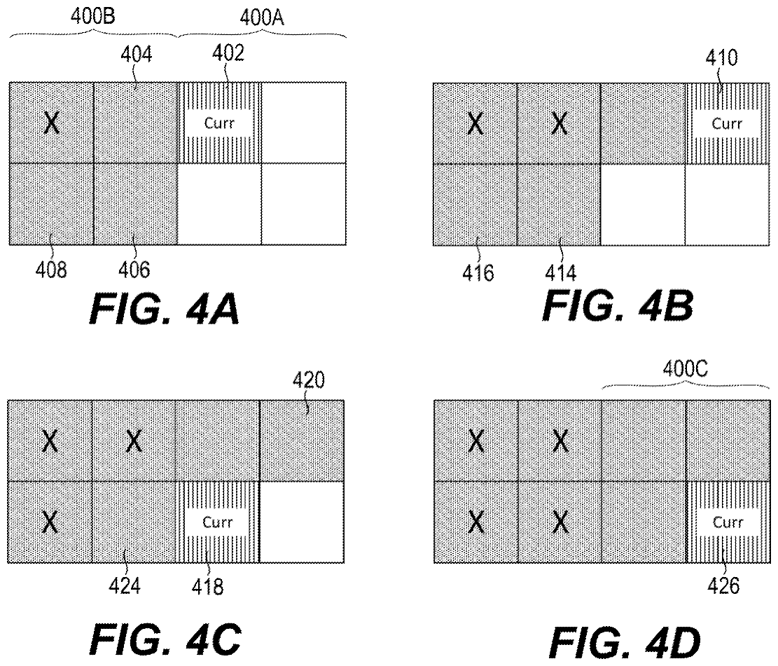

To reduce memory consumption and decoder complexity, the IBC can be applied to a reconstructed portion of a predefined area that includes a region of a current CTU and some regions of a left CTU. FIGS. 4A, 4B, 4C, and 4D show exemplary reference regions of IBC mode, where each block can represent a 64×64 luma sample unit.

Depending on a location of a current coding CU location within a current CTU, reference regions of IBC mode can be defined as follows:

(1) As shown in FIG. 4A, if a current block falls into a top-left 64×64 block (402) of a current CTU (400A), then in addition to already reconstructed samples in the current CTU, the current block can also refer to reference samples in a bottom-right 64×64 block (406) of a left CTU (400B), using CPR mode. The current block can also refer to reference samples in a bottom-left 64×64 block (408) of the left CTU and reference samples in a top-right 64×64 block (404) of the left CTU, using CPR mode.

(2) As shown in FIG. 4B, if a current block falls into a top-right 64×64 block (410) of a current CTU, then in addition to already reconstructed samples in the current CTU, if a luma location (0, 64) relative to the current CTU has not yet been reconstructed, the current block can also refer to reference samples in a bottom-left 64×64 block (416) and a bottom-right 64×64 block (414) of a left CTU, using CPR mode. Otherwise, the current block can also refer to reference samples in the bottom-right 64×64 block (414) of the left CTU.

(3) As shown in FIG. 4C, if a current block falls into a bottom-left 64×64 block (418) of a current CTU, then in addition to already reconstructed samples in the current CTU, if a luma location (64, 0) relative to the current CTU has not yet been reconstructed, the current block can also refer to reference samples in a top-right 64×64 block (420) of the current CTU and a bottom-right 64×64 block (424) of the left CTU, using CPR mode. Otherwise, the current block can also refer to the reference samples in the bottom-right 64×64 block (424) of the left CTU, using CPR mode.

(4) As shown in FIG. 4D, if a current block falls into a bottom-right 64×64 block (426) of a current CTU (400C), the current block may only refer to already reconstructed samples in the current CTU, using CPR mode.

This restriction can allow the IBC mode to be implemented using a local on-chip memory for hardware implementations.

A reconstruction-reordered IBC (RR-IBC) mode can be allowed for IBC coded blocks, such as in JVET-AA0070. When RR-IBC is applied, samples in a reconstruction block can be flipped according to a flip type of the current block. At an encoder side, an original block (or current block) can be flipped before a motion search and a residual calculation for the original block, while a prediction block can be derived without flipping. At a decoder side, a reconstruction block can be flipped back to restore the original block.

Two flip methods, a horizontal flip and a vertical flip, can be supported for RR-IBC coded blocks. A syntax flag can firstly be signalled for an IBC AMVP coded block, indicating whether the reconstruction block is to be flipped. If the syntax flag indicates that the reconstruction block is to be flipped, another flag can be further signaled specifying a flip type (e.g., a vertical flip or a horizontal flip). For IBC merge, the flip type can be inherited from neighbouring blocks, without syntax signalling. Considering a horizontal symmetry or a vertical symmetry, the current block and the reference block can normally be aligned horizontally or vertically. Therefore, when a horizontal flip is applied, a vertical component of a block vector (BV) may not be signaled and may be inferred as equal to 0. Similarly, a horizontal component of the BV may not be signaled and may be inferred as equal to 0 when a vertical flip is applied.

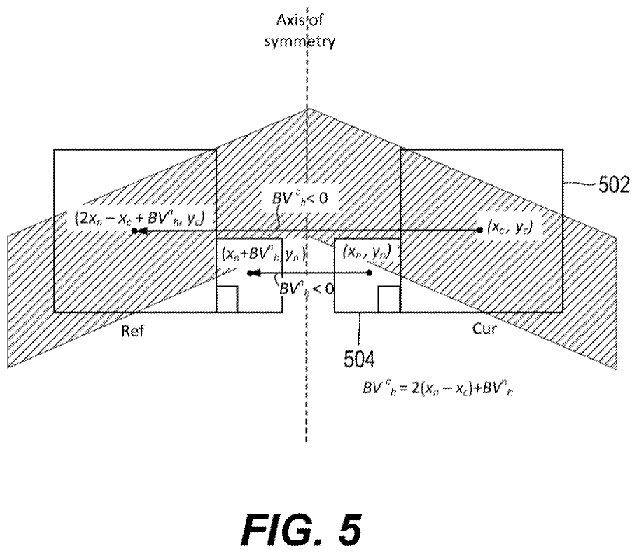

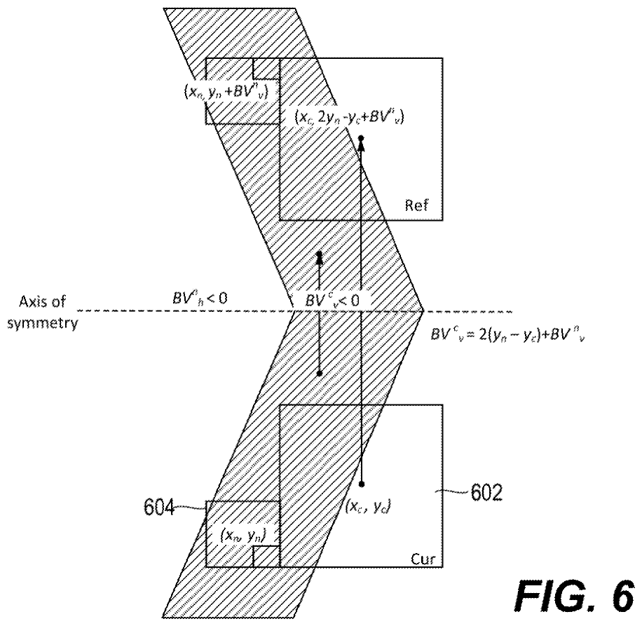

To better utilize the symmetry property, a flip-aware BV adjustment approach can be applied to refine a block vector candidate. FIG. 5 shows an exemplary BV adjustment based on a horizontal flip and FIG. 6 shows an exemplary BV adjustment based on a vertical flip. As shown in FIGS. 5 and 6, (x_{nbr}, y_{nbr}) and (x_{cur}, y_{cur}) can represent coordinates of a center sample of a neighboring block (e.g., (504) or (604)) and a current block (e.g., (502) or (602)), respectively. BV^{nbr} and BV^{cur} can denote a BV of the neighboring block (504) and the current block (502), respectively. In the horizontal flip shown in FIG. 5, instead of directly inheriting a BV from the neighboring block (504), a horizontal component of BV^{cur} of the current block (502) can be calculated by adding a motion shift to a horizontal component of BV^{nbr} (denoted as BV^{nbr}ₕ) of the neighboring block (504) in case that the neighboring block (504) is coded with a horizontal flip. Accordingly, the horizontal component of BV^{cur} of the current block (502) can be defined as BV^{cur}ₕ=2(x_{nbr}−x_{cur})+BV^{nbr}ₕ. Similarly, in the vertical flip shown in FIG. 6, a vertical component of BV^{cur} of the current block (602) can be calculated by adding a motion shift to a vertical component of BV^{nbr} (denoted as BV^{nbr}ᵥ) of the neighboring block (604) in case that the neighboring block (604) is coded with a vertical flip. Accordingly, the vertical component of BV^{cur} of the current block (602) can be defined as BV^{cur}ᵥ=2(y_{nbr}−y_{cur})+BV^{nbr}ᵥ.

Intra template matching prediction (IntraTMP) can be a type of intra prediction mode for a current block, such as in ECM software. The IntraTMP can copy a best prediction block (e.g., a prediction block with a least difference from the current block) from a reconstructed part of a current frame, where a L-shaped template of the reconstructed part matches a current template of the current block. For a predefined search range, an encoder can search for a most similar template to the current template in a reconstructed part of the current frame and use the corresponding block as a prediction block for the current block. The encoder then can signal the usage of the IntraTMP mode, and a same prediction operation can be performed at the decoder side.

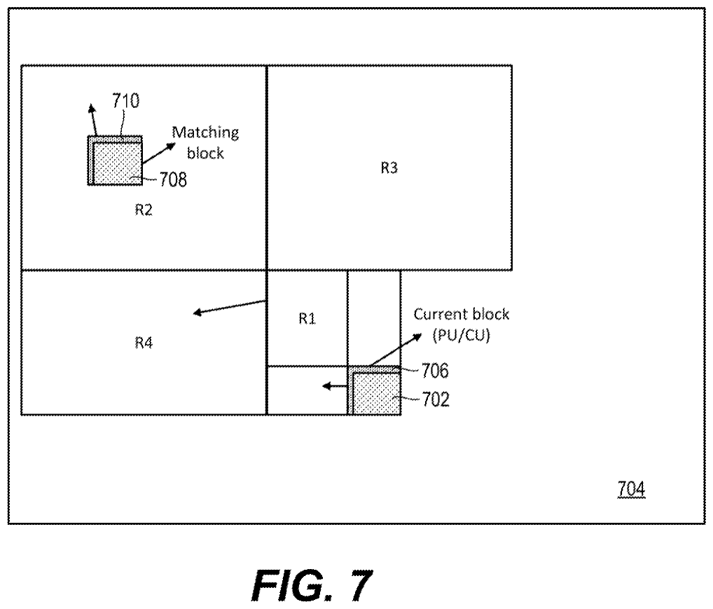

The prediction signal can be generated by matching the L-shaped causal neighbor of the current block with another block in a predefined search area. An exemplary IntraTMP process can be shown in FIG. 7. As shown in FIG. 7, a current block (702) in a current frame (704) can include an L-shaped template (706) that is adjacent to the current block (702). The search regions to determine a reference block for the current block (702) can include (1) R1: a current CTU, (2) R2: a top-left CTU, (3) R3: an above CTU, (4) R4: a left CTU. In the search process, a cost function, such as sum of absolute differences (SAD), can be used. Within each region (e.g., R1, R2, R3, and R4), the decoder can search for a template (e.g., (710)) that has a least SAD with respect to the current one (e.g., template (706)). A block (e.g., (708)) corresponding to the template (e.g., (710)) can be used as a prediction block. The dimensions of all regions (e.g., SearchRange w, SearchRange h) can be set as proportional to a block dimension (e.g., BlkW, BlkH) of the current block (402) to have a fixed number of SAD comparisons per pixel. For example, the dimension of a search region can be defined in equations (1) and (2) as follows:

SearchRange_w=a*BlkW Eq. (1)

SearchRange_h=a*BlkH Eq. (2)

where a can be a constant that controls a gain/complexity trade-off. In an example, a is equal to 5.

The Intra template matching tool can be enabled for CUs with a size less than or equal to 64 in a width and/or a height. A maximum CU size for intra template matching can be configurable.

The intra template matching prediction mode can be signaled at a CU level through a dedicated flag when decoder-side intra mode derivation (DIMD) may not be used for the current CU.

While IntraTMP mode allows template matching with L-type templates, as noted above, introducing multiple types of templates for template matching can be beneficial to improve the accuracy of template matching, thereby improve coding performance.

IBC mode may not be applied for a chroma color component when a partitioning tree between a luma component and the chroma component is different, such as in VVC. However, IBC can be applied on the chroma component to provide coding gains. When IBC is applied on a chroma component, such as on top of ECM, how to reuse luma IBC mode information (e.g., an IBC flipping mode) for a chroma component may need to be designed.

In IntraTMP mode, it is assumed that flipping does not exist between a reference block and a current block, which may limit a coding performance of IntraTMP mode.

In the disclosure, Reconstruction-Reordered (or namely flipping) mode can be applied for intra template matching (namely RR-ITM). For a current block predicted using intra template matching, when RR-ITM is applied, samples in a reconstruction block of the current block can be flipped according to a flip type of the current block. For example, at an encoder side, an original block (or current block) can be flipped before a motion search and a residual calculation, while a prediction block can be derived without flipping. At a decoder side, a reconstruction block can be flipped back to restore the original block.

In an example, at an encoder side, a flip mode, such as a horizontal flip or a vertical flip, can be determined for a current block in a current picture. The current block can be flipped (e.g., flipped vertically or flipped horizontally) in the current picture such that locations of samples of the current block are flipped within the current block based on the determined flip mode. A prediction block can be determined from a plurality of candidate prediction blocks in the current picture for the flipped current block based on template matching (TM) costs. The TM costs can indicate differences between a template of the flipped current block and respective templates of the plurality of candidate prediction blocks. Further, the current block can be encoded based on the determined prediction block. In an example, a residual block which indicates a difference between the flipped current block and the determined prediction block can be encoded. In an example, the determined prediction block can also be flipped based on the flip mode. A residual block which indicates a difference between the flipped current block and the flipped prediction block can be encoded.

In an example, the flip mode can include a vertical flip configured to adjust locations of samples of a block (e.g., a current block, a reconstruction block of the current block, a prediction block of the current block, or a reference block of the current block) such that an upper part and a lower part of the block are reversed within the block with respect to a horizontal partition line, where the block is divided into the upper part and the lower part by the horizontal partition line equally. In an example, the flip mode can include a horizontal flip configured to adjust the locations of the samples of the block such that a left part and a right part of the block are reversed within the block with respect to a vertical partition line, where the block is divided into the left part and the right part by the vertical partition line equally.

In an example, at a decoder side, a video bitstream comprising coding information of a current block in a current picture can be received. The coding information can indicate that the current block is coded by a flip mode in which locations of samples of the current block are flipped within the current block when the current block is encoded in an encoder. A reference block can be determined from a plurality of candidate reference blocks for the current block in a reconstructed region of the current picture based on template matching (TM) costs. The TM costs can indicate differences between a template of the current block and respective templates of the plurality of candidate reference blocks. A reconstruction block of the current block can be determined based on the determined reference block. The current block can be reconstructed by adjusting locations of samples of the reconstruction block based on the flip mode. In an example, the reconstruction block can be determined as a sum of the determined reference block and a residual block. The residual block can be obtained from the coding information. In an example, the determined reference block can be flipped according to the flip mode at first. The reconstruction block can be determined as a sum of the flipped reference block and the residual block.

In an example, the plurality of candidate reference blocks can be determined within a search region of the reconstructed region of the current picture. The TM costs between the template of the current block and a template of each of the plurality of candidate reference blocks can be determined. The reference block can be determined from the plurality of candidate reference blocks that corresponds to a minimum TM cost among the TM costs between the template of the current block and the templates of the plurality of candidate reference blocks.

In an aspect, a plurality of flip methods may be supported for RR-ITM coded blocks. In an example, the plurality of flip methods includes two flip methods, a horizontal flip and a vertical flip. In an aspect, one or more syntax elements may be signaled to indicate whether the reconstruction block is flipped and/or a flip type. In an example, a syntax flag can firstly be signalled to indicate whether a reconstruction block is to be flipped. If the syntax flag indicates that the reconstruction block is to be flipped, another flag can further be signaled specifying a flip type (e.g., a horizontal flip or a vertical flip).

In an example, first coding information (e.g., a first syntax flag) of the received video bitstream can indicate whether the flip mode is to be applied to the reconstruction block. In response to the first coding information indicating that the flip mode is to be applied to the reconstructed block, a type of the flip mode is determined based on second coding information (e.g., a second syntax flag) of the received video bitstream. The current block can be reconstructed by adjusting the locations of the samples of the reconstruction block based on the determined type of the flip mode.

In an aspect, one or more different search ranges can be applied in the case of flipping. In an example, when template matching is applied, for a horizontal flip and a vertical flip, a different search range of the template matching process can be applied.

In an aspect, for the horizontal flip mode, template matching search candidate positions (or candidate search positions of template matching) can have a smaller vertical range than a horizontal range. For example, search candidate positions in the horizontal flip can have a same vertical coordinate as the current block. In an aspect, for the vertical flip mode, template matching search candidate positions (or candidate search positions of template matching) can have a smaller horizontal range than a vertical range. For example, search candidate positions can have a same horizontal coordinate as the current block.

In an example, based on the flip mode being a horizontal flip, a vertical range of the search region is smaller than a horizontal range of the search region. In an example, based on the flip mode being a vertical flip, the vertical range of the search region is larger than a horizontal range of the search region.

In an aspect, a horizontal flip and/or a vertical flip can have a same search candidate number as a non-flip mode.

In an aspect, when different coding block partitioning is applied to a luma component and a chroma component of a picture, and if IBC mode is applied to a luma area, related mode information of the luma area can be reused for predicting collocated chroma color component (or chroma block). In addition, the luma area corresponding to the chroma block may cover more than one luma coding block and a boundary of a luma block may not fully align with a boundary of the chroma block.

In an aspect, mode information reused for chroma can include, but is not limited to an IBC flipping mode (e.g., a horizontal flip or a vertical flip), block vector (BV), an IBC rotation mode (e.g., a rotation angle), an IBC geometric partition mode (e.g., a partitioning pattern). In an aspect, when luma mode information is applied on chroma samples, the luma mode information, such as a BV component, size related parameters, and distance related parameters, that is used in calculation can be scaled according to a chroma sampling format.

In an aspect, for certain IBC modes, a chroma block may not inherit IBC mode information from a luma area (or luma block). Exemplary IBC modes can include, but are not limited to an IBC horizontal flipping mode and/or an IBC vertical flipping mode.

In the disclosure, whether a characteristic value of a collocated luma block of a current chroma block is larger than a predefined threshold value can be determined. The characteristic value can be associated with one or more predefined coding modes that is applied to the collocated luma block. Based on the characteristic value being larger than the predefined threshold value, chroma coding mode information of the current chroma block can be determined based on luma coding mode information of a predefined luma block. In an example, the characteristic value indicates one of (i) a number of luma collocated block positions in the collocated luma block that is coded by the one or more predefined coding modes, (ii) a size of a luma area in the collocated luma block that is coded by the one or more predefined coding modes, and (iii) a ratio of a luma area in the collocated luma block that is coded by the one or more predefined coding modes. In an example, the one or more predefined coding modes can include at least one of an intra block copy (IBC) flipping mode, an IBC mode indicating by a block vector (BV), an IBC rotation mode, and an IBC geometric partition mode. In an example, the chroma coding mode information of the current chroma block can be determined based on scaled luma coding mode information of the predefined luma block according to a scaling factor, where the scaling factor is determined based on a sampling format of the current chroma block.

In an aspect, a set of luma collocated block positions can be predefined for a current chroma block. If more than thr1 number of the luma positions are coded by one or multiple predefined IBC modes, then IBC mode information associated with a predefined luma block can be inherited for the current chroma block. thr1 can be a predefined threshold value or can be signaled, for example by a high-level syntax, such as at a sequence level, a picture level, a slice level, or the like. In an example, the set of luma collocated block positions can include but is not limited to a center position, and four corner positions of a collocated luma block of the current chroma block.

In an aspect, IBC mode information associated with a first IBC coded block along a given scanning order can be fetched and reused for a collocated chroma block. In an aspect, a most frequently used IBC mode information among the predefined luma collocated block positions can be fetched and reused for a collocated chroma block. In an aspect, first IBC mode information that has been used more than N times along a given scanning order can be fetched and reused for a collocated chroma block. An exemplary value of N can be an integer, such as 1, 2, 3, or 4.

In an aspect, in a collocated luma block area of a current chroma block, if a characteristic value, such as a luma area size covered by the one or multiple predefined IBC mode, is greater than thr2, then IBC mode information associated with a predefined luma block can be inherited for the current chroma block. thr2 can be a predefined threshold value or can be signaled, for example by a high-level syntax, such as at a sequence level, a picture level, a slice level, or the like.

In an aspect, IBC mode information associated with a first IBC coded block along a given scanning order can be fetched and reused for a collocated chroma block. In an aspect, a most frequently used IBC mode information among the predefined luma collocated block positions can be fetched and reused for a collocated chroma block. In an aspect, first IBC mode information that has been used more than N times along a given scanning order can be fetched and reused for a collocated chroma block. An exemplary value of N can be a positive integer, such as 1, 2, 3, or 4.

In an aspect, in a collocated luma block area, if a characteristic value, such as a ratio of the collocated luma block area covered by the one or multiple predefined IBC mode, is greater than thr3, then IBC mode information associated with a predefined luma block can be inherited for a chroma block. thr3 can be a predefined threshold value or can be signaled, for example by a high-level syntax, such as at a sequence level, a picture level, a slice level, or the like.

In an aspect, IBC mode information associated with first IBC coded block along a given scanning order can be fetched and reused for a collocated chroma block. In an aspect, most frequently used IBC mode information among the predefined luma collocated block positions can be fetched and reused for a collocated chroma block. In an aspect, first IBC mode information that has been used more than N times along a given scanning order can be fetched and reused for a collocated chroma block. An exemplary value of N can be integer, such as 1, 2, 3, or 4.

In an example, the chroma coding mode information of the current chroma block can be determined based on one of (i) luma coding mode information of a first luma block that is coded by the one of the one or more predefined coding modes along a predefined scanning order, (ii) luma coding mode information of a most frequently used mode among the luma collocated block positions that are coded by the one or more predefined coding modes, and (iii) first luma coding mode information of the one or more predefined coding modes that is used more than N times along a predefined scanning order, where N can be a positive integer.

In an aspect, a specific collocated luma position can be predefined. If a coding mode associated with a sample located at the predefined luma position is coded by an IBC mode, then IBC mode information associated with the sample can be inherited for a chroma block. Examples of the specific collocated luma position can include but not limited to a center position of a collocated luma block of the chroma block, or a top-left position of the collocated luma block.

In an example, the chroma coding mode information of the current chroma block can be determined based on luma coding mode information of a sample at a predefined collocated luma position. The sample at the predefined collocated luma position can be coded by one of the one or more predefined coding modes, and the predefined collocated luma position can include one of a center position and a top-left position of the collocated luma block.

In an aspect, when different coding block partitioning is applied to a luma component and a collocated chroma component of a picture, and if ITM mode (or IntraTMP) is applied to the luma component, related mode information of the luma component can be reused for predicting the collocated chroma color component.

In an aspect, mode information reused for a chroma block can include, but is not limited to an IntraTMP flipping mode (e.g., a horizontal flip or a vertical flip), a displacement vector used for IntraTMP.

In an aspect, for certain IntraTMP modes, a chroma block may not inherit IntraTMP mode information from a luma block. Exemplary IntraTMP modes can include, but are not limited to an IntraTMP horizontal flipping mode and/or an IntraTMP vertical flipping mode.

In an aspect, a set of luma collocated block positions can be predefined for a current chroma block. If more than thr1 number of the luma collocated block positions are coded by one or multiple predefined IntraTMP mode, then IntraTMP mode information associated with a predefined luma block can be inherited for the current chroma block. thr1 can be a predefined threshold value or can be signaled, for example by a high-level syntax, such as at a sequence level, a picture level, a slice level, or the like. In an example, the set of luma collocated block positions can include but is not limited to a center position, and four corner positions of a collocated luma block of the current chroma block.

In an example, the one or more predefined coding modes include at least one of an intra template matching prediction (IntraTMP) flipping mode and an IntraTMP mode indicated by a displacement vector.

In an aspect, IntraTMP mode information associated with a first IntraTMP coded block along a given scanning order can be fetched and reused for a collocated chroma block. In an aspect, most frequently used IntraTMP mode information among the predefined luma collocated block positions can be fetched and reused for a collocated chroma block. In an aspect, first IntraTMP mode information that has been used more than N times along a given scanning order can be fetched and reused for a collocated chroma block. An exemplary value of N can be a positive integer, such as 1, 2, 3, or 4.

In an aspect, in a collocated luma block area of a chroma block, if a luma area size covered by the one or multiple predefined IntraTMP mode is greater than thr2, then IntraTMP mode information associated with a predefined luma block can be inherited for the chroma block. thr2 can be a predefined threshold value or can be signaled, for example by a high-level syntax, such as at a sequence level, a picture level, a slice level, or the like.

In an aspect, IntraTMP mode information associated with a first IntraTMP coded block along a given scanning order can be fetched and reused for a collocated chroma block. In an aspect, most frequently used IntraTMP mode information among the predefined luma collocated block positions can be fetched and reused for a collocated chroma block. In an aspect, first IntraTMP mode information that has been used more than N times along a given scanning order can be fetched and reused for a collocated chroma block. An exemplary value of N can be a positive integer, such as 1, 2, 3, or 4.

In an aspect, in a collocated luma block area of a chroma block, if a ratio of the collocated luma block area size covered by the one or multiple predefined IntraTMP mode is greater than thr2, then IntraTMP mode information associated with a predefined luma block can be inherited for the chroma block. thr2 can be a predefined threshold value or can be signaled, for example by a high-level syntax, such as at a sequence level, a picture level, a slice level, or the like.

In an aspect, IntraTMP mode information associated with a first IntraTMP coded block along a given scanning order can be fetched and reused for a collocated chroma block. In an aspect, most frequently used IntraTMP mode information among the predefined luma collocated block positions can be fetched and reused for a collocated chroma block. In an aspect, first IntraTMP mode information that has been used more than N times along a given scanning order can be fetched and reused for a collocated chroma block. An exemplary value of N can be a positive integer, such as 1, 2, 3, or 4.

In an aspect, search candidates which are pointed by a block vector of associated luma IntraTMP blocks with a scaling factor of a subsampling ratio can be searched to find a best (or selected) template matching with a smallest template-matching cost. In an example, the associated luma IntraTMP blocks can include (i) a first IntraTMP coded block along a predefined scanning order, (ii) a collocated luma block, and (iii) an IntraTMP coded block corresponding to first IntraTMP mode information that is used more than N times.

In an aspect, a flip mode of each search candidate can be inherited from a flip mode of an associated IntraTMP luma block. In an aspect, template-matching can be performed on all possible flip modes (e.g., a vertical flip or a horizontal flip) for each candidate to find a best (or selected) flip mode with a smallest template-matching cost. In an aspect, a flip mode can be signaled for each chroma coding unit.

In an example, based on the one or more predefined coding modes including an IntraTMP mode, a plurality of candidate reference chroma blocks can be determined within a search range in the current picture that is indicated by a block vector (BV) of the current chroma block. The BV of the current chroma block can be determined based on one of a plurality of associated luma blocks. The plurality of associated luma blocks includes (i) a first IntraTMP coded block along a predefined scanning order, (ii) the collocated luma block, and (iii) an IntraTMP coded block corresponding to first IntraTMP mode information that is used more than N times along a predefined scanning order. A plurality of flip modes can be determined for each of the plurality of candidate reference chroma blocks. TM cost between a template of each of the plurality of candidate reference chroma blocks and a template of the current chroma block can be determined according to a respective flip mode of the plurality of flip modes. A flip mode can be determined from the plurality of flip modes that corresponds to a smallest TM cost among the TM costs between the template of each of the plurality of candidate reference chroma blocks and the template of the current chroma block according to the plurality of flip modes. A flip mode of the current chroma block can be determined as the determined flip mode from the plurality of flip modes.

In an example, the BV of the current chroma block can be determined as a scaled BV of the one of the plurality of associated luma blocks based on a scaling factor, where the scaling factor can be determined based on a subsampling ratio associated with the current chroma block.

In an aspect, a specific collocated luma position can be predefined. If a coding mode associated with a sample located at the predefined luma position is coded by an IntraTMP mode, then IntraTMP mode information associated with the sample can be inherited for the chroma block. In an example, the specific collocated luma position can include but is not limited to a center position of the collocated luma area for the current chroma block.

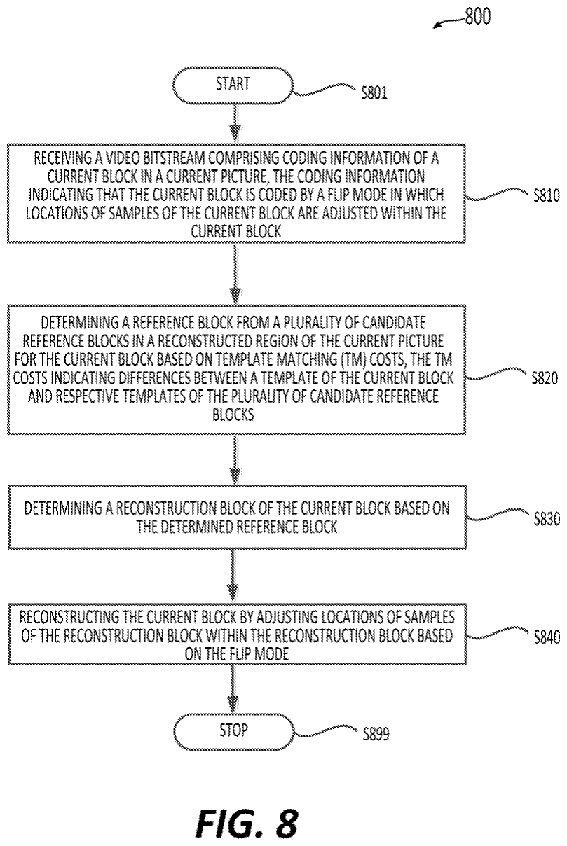

FIG. 8 shows a flow chart outlining a process (800) according to an embodiment of the disclosure. The process (800) can be used in a video decoder. In various embodiments, the process (800) is executed by processing circuitry, such as the processing circuitry that performs functions of the video decoder (110), the processing circuitry that performs functions of the video decoder (210), and the like. In some embodiments, the process (800) is implemented in software instructions, thus when the processing circuitry executes the software instructions, the processing circuitry performs the process (800). The process starts at (S801) and proceeds to (S810).

At (S810), a video bitstream comprising coding information of a current block in a current picture is received. The coding information indicates that the current block is coded by a flip mode in which locations of samples of the current block are adjusted within the current block.

At (S820), a reference block is determined from a plurality of candidate reference blocks in a reconstructed region of the current picture for the current block based on template matching (TM) costs. The TM costs indicate differences between a template of the current block and respective templates of the plurality of candidate reference blocks.

At (S830), a reconstruction block of the current block is determined based on the determined reference block.

At (S840), the current block is reconstructed by adjusting locations of samples of the reconstruction block within the reconstruction block based on the flip mode.

In an example, the flip mode includes one of (i) a vertical flip mode configured to adjust the locations of the samples of the current block such that an upper part and a lower part of the current block are reversed within the current block, and (ii) a horizontal flip mode configured to adjust the locations of the samples of the current block such that a left part and a right part of the current block are reversed within the current block.

In an example, first coding information is received from the received video bitstream. The first coding information indicates whether the flip mode is to be applied to the reconstruction block. In response to the first coding information indicating that the flip mode is to be applied to the reconstruction block, a type of the flip mode is determined based on second coding information in the received video bitstream. The current block is reconstructed by adjusting the locations of the samples of the reconstruction block based on the determined type of the flip mode.

In an example, the plurality of candidate reference blocks is determined within a search region of the reconstructed region of the current picture. The TM costs between the template of the current block and a template of each of the plurality of candidate reference blocks are determined. The reference block is determined from the plurality of candidate reference blocks that corresponds to a minimum TM cost among the TM costs between the template of the current block and the templates of the plurality of candidate reference blocks.

In an example, based on the flip mode being a horizontal flip, a vertical range of the search region is smaller than a horizontal range of the search region. In an example, based on the flip mode being a vertical flip, the vertical range of the search region is larger than a horizontal range of the search region.

In an example, the determined reference block is further flipped by adjusting locations of samples of the determined reference block within the determined reference block based on the flip mode. The reconstruction block is determined based on the flipped reference block.

Then, the process proceeds to (S899) and terminates.

The process (800) can be suitably adapted. Step(s) in the process (800) can be modified and/or omitted. Additional step(s) can be added. Any suitable order of implementation can be used.

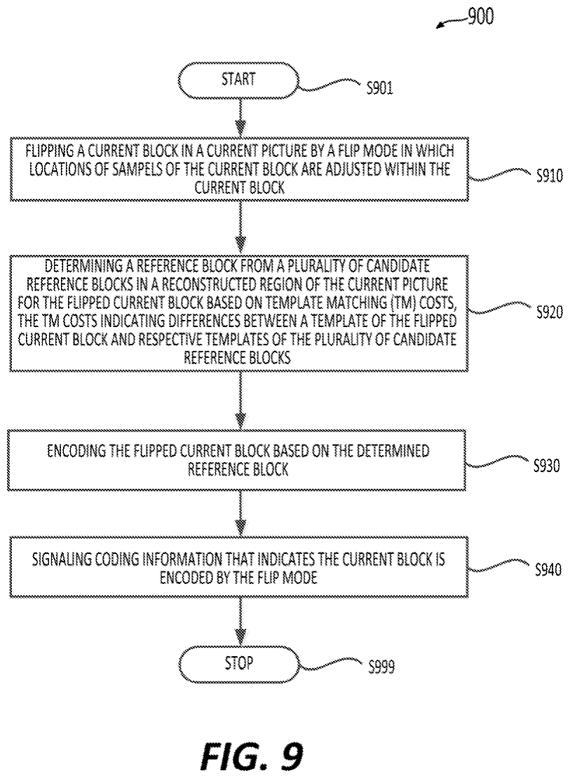

FIG. 9 shows a flow chart outlining a process (900) according to an embodiment of the disclosure. The process (900) can be used in a video encoder. In various embodiments, the process (900) is executed by processing circuitry, such as the processing circuitry that performs functions of the video encoder (103), the processing circuitry that performs functions of the video encoder (303), and the like. In some embodiments, the process (900) is implemented in software instructions, thus when the processing circuitry executes the software instructions, the processing circuitry performs the process (900). The process starts at (S901) and proceeds to (S910).

At (S910), a current block in a current picture is flipped by a flip mode in which locations of samples of the current block are adjusted within the current block.

At (S920), a reference block is determined from a plurality of candidate reference blocks in a reconstructed region of the current picture for the flipped current block based on template matching (TM) costs, where the TM costs indicates differences between a template of the flipped current block and respective templates of the plurality of candidate reference blocks.

At (S930), the flipped current block is encoded based on the determined reference block.

At (S940), coding information that indicates the current block is encoded by the flip mode is signaled.

Then, the process proceeds to (S999) and terminates.

The process (900) can be suitably adapted. Step(s) in the process (900) can be modified and/or omitted. Additional step(s) can be added. Any suitable order of implementation can be used.

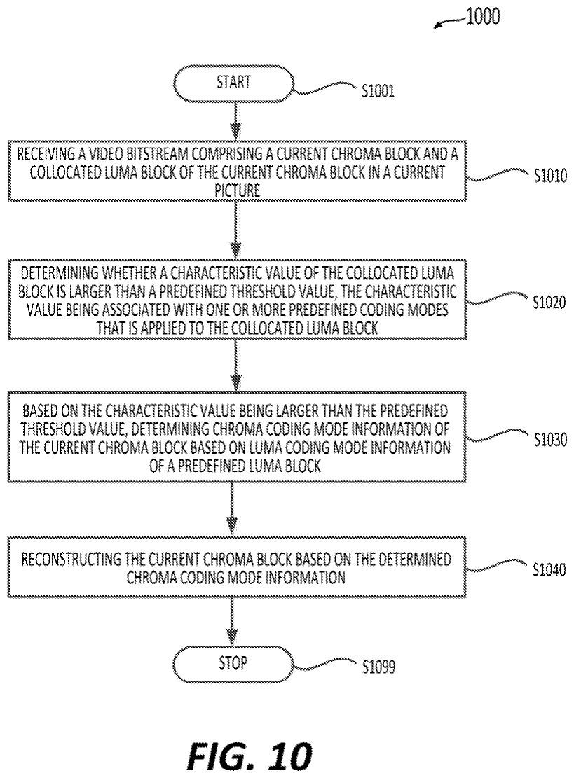

FIG. 10 shows a flow chart outlining a process (1000) according to an embodiment of the disclosure. The process (1000) can be used in a video decoder. In various embodiments, the process (1000) is executed by processing circuitry, such as the processing circuitry that performs functions of the video decoder (110), the processing circuitry that performs functions of the video decoder (210), and the like. In some embodiments, the process (1000) is implemented in software instructions, thus when the processing circuitry executes the software instructions, the processing circuitry performs the process (1000). The process starts at (S1001) and proceeds to (S1010).

At (S1010), a video bitstream comprising a current chroma block and a collocated luma block of the current chroma block in a current picture is determined.

At (S1020), whether a characteristic value of the collocated luma block is larger than a predefined threshold value is determined. The characteristic value is associated with one or more predefined coding modes that is applied to the collocated luma block.

At (S1030), based on the characteristic value being larger than the predefined threshold value, chroma coding mode information of the current chroma block is determined based on luma coding mode information of a predefined luma block.

At (S1040), the current chroma block is reconstructed based on the determined chroma coding mode information.

In an example, the characteristic value indicates one of (i) a number of luma collocated block positions in the collocated luma block that is coded by the one or more predefined coding modes, (ii) a size of a luma area in the collocated luma block that is coded by the one or more predefined coding modes, and (iii) a ratio of a luma area in the collocated luma block that is coded by the one or more predefined coding modes.

In an example, the luma collocated block positions include a center position and four corner positions of the collocated luma block.

In an example, the one or more predefined coding modes include at least one of an intra block copy (IBC) flipping mode, an IBC mode indicating by a block vector (BV), an IBC rotation mode, and an IBC geometric partition mode.

In an example, the one or more predefined coding modes include at least one of an intra template matching prediction (IntraTMP) flipping mode and an IntraTMP mode indicated by a displacement vector.

In an example, the chroma coding mode information of the current chroma block is determined based on one of (i) luma coding mode information of a first luma block that is coded by the one of the one or more predefined coding modes along a predefined scanning order, (ii) luma coding mode information of a most frequently used mode among the luma collocated block positions that are coded by the one or more predefined coding modes, and (iii) first luma coding mode information of the one or more predefined coding modes that is used more than N times along a predefined scanning order, where N is a positive integer.

In an example, the chroma coding mode information of the current chroma block is determined based on luma coding mode information of a sample at a predefined collocated luma position. The sample at the predefined collocated luma position is coded by one of the one or more predefined coding modes, and the predefined collocated luma position includes one of a center position and a top-left position of the collocated luma block.

In an example, based on the one or more predefined coding modes including an IntraTMP mode, a plurality of candidate reference chroma blocks is determined within a search range in the current picture that is indicated by a block vector (BV) of the current chroma block. The BV of the current chroma block is determined based on one of a plurality of associated luma blocks. The plurality of associated luma blocks includes (i) a first IntraTMP coded block along a predefined scanning order, (ii) the collocated luma block, and (iii) an IntraTMP coded block corresponding to first IntraTMP mode information that is used more than N times along a predefined scanning order. A plurality of flip modes is determined for each of the plurality of candidate reference chroma blocks. TM cost between a template of each of the plurality of candidate reference chroma blocks and a template of the current chroma block are determined according to a respective flip mode of the plurality of flip modes. A flip mode is determined from the plurality of flip modes that corresponds to a smallest TM cost among the TM costs between the template of each of the plurality of candidate reference chroma blocks and the template of the current chroma block according to the plurality of flip modes. A flip mode of the current chroma block is determined as the determined flip mode from the plurality of flip modes.

In an example, the BV of the current chroma block is determined as a scaled BV of the one of the plurality of associated luma blocks based on a scaling factor, where the scaling factor is determined based on a subsampling ratio associated with the current chroma block.

In an example, the chroma coding mode information of the current chroma block is determined based on scaled luma coding mode information of the predefined luma block according to a scaling factor, where the scaling factor is determined based on a sampling format of the current chroma block.

Then, the process proceeds to (S1099) and terminates.

The process (1000) can be suitably adapted. Step(s) in the process (1000) can be modified and/or omitted. Additional step(s) can be added. Any suitable order of implementation can be used.

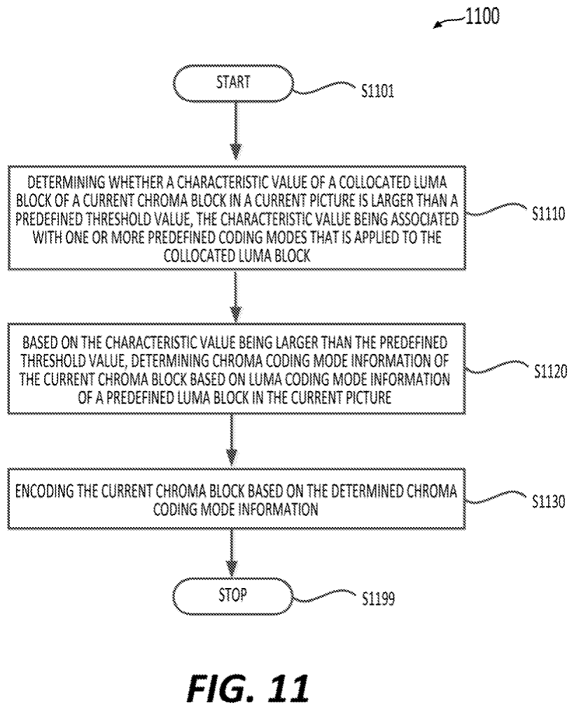

FIG. 11 shows a flow chart outlining a process (1100) according to an embodiment of the disclosure. The process (1100) can be used in a video encoder. In various embodiments, the process (1100) is executed by processing circuitry, such as the processing circuitry that performs functions of the video encoder (103), the processing circuitry that performs functions of the video encoder (303), and the like. In some embodiments, the process (1100) is implemented in software instructions, thus when the processing circuitry executes the software instructions, the processing circuitry performs the process (1100). The process starts at (S1101) and proceeds to (S1110).

At (S1110), whether a characteristic value of a collocated luma block of a current chroma block in a current picture is larger than a predefined threshold value is determined. The characteristic value is associated with one or more predefined coding modes that is applied to the collocated luma block.

At (S1120), based on the characteristic value being larger than the predefined threshold value, chroma coding mode information of the current chroma block is determined based on luma coding mode information of a predefined luma block in the current picture.

At (S1130), the current chroma block is encoded based on the determined chroma coding mode information.

Then, the process proceeds to (S1199) and terminates.

The process (1100) can be suitably adapted. Step(s) in the process (1100) can be modified and/or omitted. Additional step(s) can be added. Any suitable order of implementation can be used.

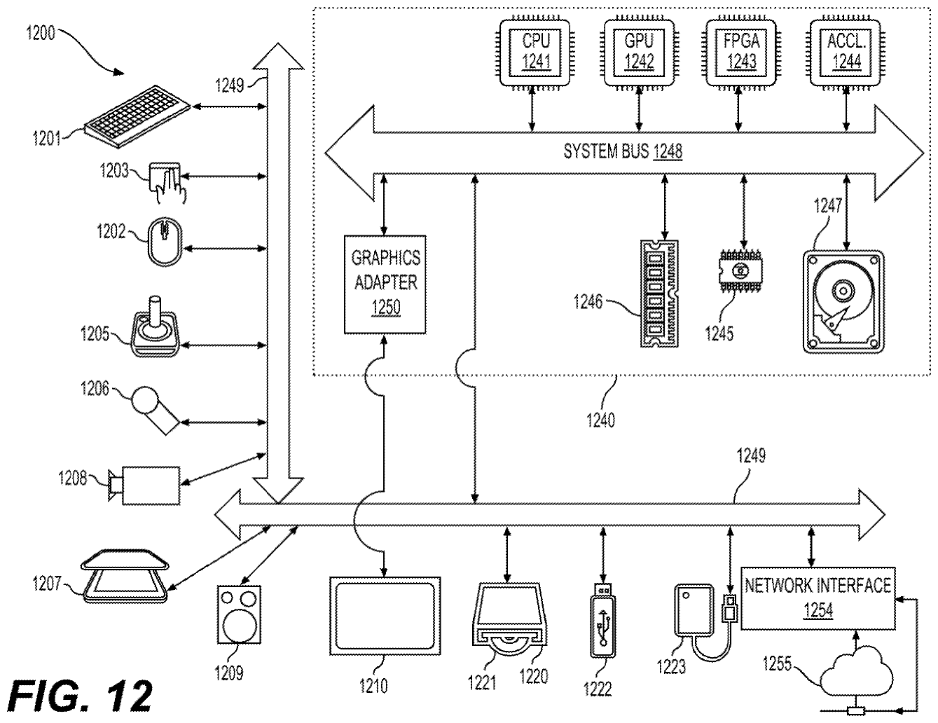

The techniques described above, can be implemented as computer software using computer-readable instructions and physically stored in one or more computer-readable media. For example, FIG. 12 shows a computer system (1200) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 12 for computer system (1200) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1200).

Computer system (1200) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1201), mouse (1202), trackpad (1203), touch screen (1210), data-glove (not shown), joystick (1205), microphone (1206), scanner (1207), camera (1208).

Computer system (1200) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1210), data-glove (not shown), or joystick (1205), but there can also be tactile feedback devices that do not serve as input devices), audio output devices (such as: speakers (1209), headphones (not depicted)), visual output devices (such as screens (1210) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1200) can also include human accessible storage devices and their associated media such as optical media including CD/DVD ROM/RW (1220) with CD/DVD or the like media (1221), thumb-drive (1222), removable hard drive or solid state drive (1223), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1200) can also include an interface (1254) to one or more communication networks (1255). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1249) (such as, for example USB ports of the computer system (1200)); others are commonly integrated into the core of the computer system (1200) by attachment to a system bus as described below (for example Ethernet interface into a PC computer system or cellular network interface into a smartphone computer system). Using any of these networks, computer system (1200) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1240) of the computer system (1200).

The core (1240) can include one or more Central Processing Units (CPU) (1241), Graphics Processing Units (GPU) (1242), specialized programmable processing units in the form of Field Programmable Gate Areas (FPGA) (1243), hardware accelerators for certain tasks (1244), graphics adapters (1250), and so forth. These devices, along with Read-only memory (ROM) (1245), Random-access memory (1246), internal mass storage such as internal non-user accessible hard drives, SSDs, and the like (1247), may be connected through a system bus (1248). In some computer systems, the system bus (1248) can be accessible in the form of one or more physical plugs to enable extensions by additional CPUs, GPU, and the like. The peripheral devices can be attached either directly to the core's system bus (1248), or through a peripheral bus (1249). In an example, the screen (1210) can be connected to the graphics adapter (1250). Architectures for a peripheral bus include PCI, USB, and the like.

CPUs (1241), GPUs (1242), FPGAs (1243), and accelerators (1244) can execute certain instructions that, in combination, can make up the aforementioned computer code. That computer code can be stored in ROM (1245) or RAM (1246). Transitional data can also be stored in RAM (1246), whereas permanent data can be stored for example, in the internal mass storage (1247). Fast storage and retrieve to any of the memory devices can be enabled through the use of cache memory, that can be closely associated with one or more CPU (1241), GPU (1242), mass storage (1247), ROM (1245), RAM (1246), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1200), and specifically the core (1240) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1240) that are of non-transitory nature, such as core-internal mass storage (1247) or ROM (1245). The software implementing various embodiments of the present disclosure can be stored in such devices and executed by core (1240). A computer-readable medium can include one or more memory devices or chips, according to particular needs. The software can cause the core (1240) and specifically the processors therein (including CPU, GPU, FPGA, and the like) to execute particular processes or particular parts of particular processes described herein, including defining data structures stored in RAM (1246) and modifying such data structures according to the processes defined by the software. In addition or as an alternative, the computer system can provide functionality as a result of logic hardwired or otherwise embodied in a circuit (for example: accelerator (1244)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of video decoding, the method comprising:
receiving a video bitstream comprising coding information of a current block in a current picture, the coding information indicating that the current block is coded by a flip mode in which locations of samples of the current block are adjusted within the current block;
determining a reference block from a plurality of candidate reference blocks in a reconstructed region of the current picture for the current block based on template matching (TM) costs, the TM costs indicating differences between a template of the current block and respective templates of the plurality of candidate reference blocks;
determining a reconstruction block of the current block based on the determined reference block; and
reconstructing the current block by adjusting locations of samples of the reconstruction block within the reconstruction block based on the flip mode.

2. The method of claim 1, wherein the flip mode includes one of (i) a vertical flip mode configured to adjust the locations of the samples of the current block such that an upper part and a lower part of the current block are reversed within the current block and (ii) a horizontal flip mode configured to adjust the locations of the samples of the current block such that a left part and a right part of the current block are reversed within the current block.

3. The method of claim 1, wherein the reconstructing the current block further comprises:
receiving first coding information from the received video bitstream, the first coding information indicating whether the flip mode is to be applied to the reconstruction block,
in response to the first coding information indicating that the flip mode is to be applied to the reconstruction block, determining a type of the flip mode based on second coding information in the received video bitstream; and
reconstructing the current block by adjusting the locations of the samples of the reconstruction block based on the determined type of the flip mode.

4. The method of claim 1, wherein the determining the reference block from the plurality of candidate reference blocks further comprises:
determining the plurality of candidate reference blocks within a search region of the reconstructed region of the current picture;
determining the TM costs between the template of the current block and a template of each of the plurality of candidate reference blocks; and
determining the reference block from the plurality of candidate reference blocks that corresponds to a minimum TM cost among the TM costs between the template of the current block and the templates of the plurality of candidate reference blocks.

5. The method of claim 4, wherein:
based on the flip mode being a horizontal flip, a vertical range of the search region is smaller than a horizontal range of the search region, and
based on the flip mode being a vertical flip, the vertical range of the search region is larger than a horizontal range of the search region.

6. The method of claim 1, wherein the determining the reconstruction block further comprises:
flipping the determined reference block by adjusting locations of samples of the determined reference block within the determined reference block based on the flip mode; and
determining the reconstruction block based on the flipped reference block.

7. A method of video decoding, the method comprising:
receiving a video bitstream comprising a current chroma block and a collocated luma block of the current chroma block in a current picture;
determining whether a characteristic value of the collocated luma block is larger than a predefined threshold value, the characteristic value being associated with one or more predefined coding modes that is applied to the collocated luma block;
based on the characteristic value being larger than the predefined threshold value, determining chroma coding mode information of the current chroma block based on luma coding mode information of a predefined luma block in the current picture; and
reconstructing the current chroma block based on the determined chroma coding mode information.

8. The method of claim 7, wherein the characteristic value indicates one of (i) a number of luma collocated block positions in the collocated luma block that is coded by the one or more predefined coding modes, (ii) a size of a luma area in the collocated luma block that is coded by the one or more predefined coding modes, and (iii) a ratio of a luma area in the collocated luma block that is coded by the one or more predefined coding modes.

9. The method of claim 8, wherein the luma collocated block positions include a center position and four corner positions of the collocated luma block.

10. The method of claim 7, wherein the one or more predefined coding modes include at least one of an intra block copy (IBC) flipping mode, an IBC mode indicating by a block vector (BV), an IBC rotation mode, and an IBC geometric partition mode.

11. The method of claim 7, wherein the one or more predefined coding modes include at least one of an intra template matching prediction (IntraTMP) flipping mode and an IntraTMP mode indicated by a displacement vector.

12. The method of claim 8, wherein the determining the chroma coding mode information further comprises:
determining the chroma coding mode information of the current chroma block based on one of (i) luma coding mode information of a first luma block that is coded by the one of the one or more predefined coding modes along a predefined scanning order, (ii) luma coding mode information of a most frequently used mode among the luma collocated block positions that are coded by the one or more predefined coding modes, and (iii) first luma coding mode information of the one or more predefined coding modes that is used more than N times along a predefined scanning order, N being a positive integer.

13. The method of claim 7, wherein the determining the chroma coding mode information further comprises:
determining the chroma coding mode information of the current chroma block based on luma coding mode information of a sample at a predefined collocated luma position, the sample at the predefined collocated luma position being coded by one of the one or more predefined coding modes, the predefined collocated luma position including one of a center position and a top-left position of the collocated luma block.

14. The method of claim 11, further comprising:
based on the one or more predefined coding modes including an IntraTMP mode,
determining a plurality of candidate reference chroma blocks within a search range in the current picture that is indicated by a block vector (BV) of the current chroma block, the BV of the current chroma block being determined based on one of a plurality of associated luma blocks, the plurality of associated luma blocks including (i) a first IntraTMP coded block along a predefined scanning order, (ii) the collocated luma block, and (iii) an IntraTMP coded block corresponding to first IntraTMP mode information that is used more than N times along a predefined scanning order;
determining a plurality of flip modes for each of the plurality of candidate reference chroma blocks;
determining a TM cost between a template of each of the plurality of candidate reference chroma blocks and a template of the current chroma block according to a respective flip mode of the plurality of flip modes;
determining a flip mode from the plurality of flip modes that corresponds to a smallest TM cost among the TM costs between the template of each of the plurality of candidate reference chroma blocks and the template of the current chroma block according to the plurality of flip modes; and
determining a flip mode of the current chroma block as the determined flip mode from the plurality of flip modes.

15. The method of claim 14, wherein the BV of the current chroma block is determined as a scaled BV of the one of the plurality of associated luma blocks based on a scaling factor, the scaling factor being determined based on a subsampling ratio associated with the current chroma block.

16. The method of claim 7, wherein the determining the chroma coding mode information further comprises:
determining the chroma coding mode information of the current chroma block based on scaled luma coding mode information of the predefined luma block according to a scaling factor, the scaling factor being determined based on a sampling format of the current chroma block.

17. An apparatus, the apparatus comprising:
processing circuitry configured to:
receive a video bitstream comprising coding information of a current block in a current picture, the coding information indicating that the current block is coded by a flip mode in which locations of samples of the current block are adjusted within the current block;
determine a reference block from a plurality of candidate reference blocks in a reconstructed region of the current picture for the current block based on template matching (TM) costs, the TM costs indicating differences between a template of the current block and respective templates of the plurality of candidate reference blocks;
determine a reconstruction block of the current block based on the determined reference block; and
reconstruct the current block by adjusting locations of samples of the reconstruction block within the reconstruction block based on the flip mode.

18. The apparatus of claim 17, wherein the flip mode includes one of (i) a vertical flip mode configured to adjust the locations of the samples of the current block such that an upper part and a lower part of the current block are reversed within the current block and (ii) a horizontal flip mode configured to adjust the locations of the samples of the current block such that a left part and a right part of the current block are reversed within the current block.

19. The apparatus of claim 17, wherein the processing circuitry is further configured to:
receive first coding information from the received video bitstream, the first coding information indicating whether the flip mode is to be applied to the reconstruction block,
in response to the first coding information indicating that the flip mode is to be applied to the reconstruction block, determine a type of the flip mode based on second coding information in the received video bitstream; and
reconstruct the current block by adjusting the locations of the samples of the reconstruction block based on the determined type of the flip mode.

20. The apparatus of claim 17, wherein the processing circuitry is further configured to:
determine the plurality of candidate reference blocks within a search region of the reconstructed region of the current picture;
determine the TM costs between the template of the current block and a template of each of the plurality of candidate reference blocks; and
determine the reference block from the plurality of candidate reference blocks that corresponds to a minimum TM cost among the TM costs between the template of the current block and the templates of the plurality of candidate reference blocks.
